(19) United States
(12) Patent Application Publication
(10) Pub. No.: US 2006/0190138 A1
(43) Pub. Date: Aug. 24, 2006

(54) Method, system and computer program for performing HVAC system set up

(76) Inventors: Kevin Stone, New Milford, CT (US); James Bailey, Watertown, CT (US); John McNabney, Harwinton, CT (US)

Correspondence Address: CANTOR COLBURN, LLP, 55 GRIFFIN ROAD SOUTH, BLOOMFIELD, CT, 06002, US

(21) Appl. No.: 11/341,040

(22) Filed: Jan. 27, 2006

Related U.S. Application Data
(60) Provisional application No. 60/647,740, filed on Jan. 27, 2005.

(51) Int. Cl. G05D 23/12; G01M 1/38; F24F 11/053

(52) U.S. Cl. 700/276; 700/278; 236/1 C

(57) ABSTRACT

A method of performing an HVAC system set up. The method includes coupling a supervisory controller to a plurality of equipment controllers, the equipment controllers communicating with the supervisory controller over a bus. The supervisory controller polls addresses associated with the bus to detect the presence of equipment controllers on the bus. An HVAC device is associated with each controller in response to an HVAC device designated through a user interface and assigning an address to the HVAC device. The supervisory controller retrieves control data from a database and loading the control data into the equipment controllers. The supervisory controller loads operating parameters into the equipment controllers.

### CROSS-REFERENCE TO RELATED APPLICATIONS

This application claims the benefit of U.S. provisional patent application Ser. No. 60/647,740 filed Jan. 27, 2005, the entire contents of which are incorporated herein by reference.

### BACKGROUND

Embodiments of the invention relate to building automation, monitoring and control of heating, ventilating and air conditioning (HVAC) components and/or subsystems and more particularly relates to devices and methods used in interfacing with existing devices and control systems, in addition to devices and methods utilized in new installation of devices and control systems.

Embodiments of the invention are particularly suitable for building automation, monitoring and control of HVAC systems for small to medium sized commercial office buildings, shopping centers, grouped retail establishments, hospitals, schools, educational campuses, and multi-zoned residential facilities which require different HVAC settings and operation for occupied and unoccupied conditions.

At present, there are a number of building automation, monitoring and control systems for HVAC applications. If these systems offer a reasonable level of complexity, they typically require the services of a trained or experienced technician and the employment of external programming equipment, often in the form of a laptop computer on which is installed a manufacturer-specific software application, to configure and commission the system. Further, in the event of a need to reconfigure or modify the presently installed arrangement of the building automation, monitoring or control system, said technician and accompanying external programming equipment and tools are typically required to perform the required reconfiguration and/or modifications.

### SUMMARY

A feature of embodiments of the present invention is to provide a means and method of monitoring, controlling and/or recording the operation of heating, ventilating and air conditioning (HVAC) components and/or subsystems without the need for external programming equipment and specialized training. A unique feature of embodiments of the invention is the pictorially graphic-based method of initial, and/or subsequent, configuration and selection of type, arrangement, feature(s) and/or desired operation of said HVAC components and/or subsystems.

It is another feature of embodiments of the invention to provide a mechanism and means to monitor and/or (optionally) control said HVAC systems, components and subsystems remotely by means of an Ethernet-TCP/IP based communication protocol; with hypertext markup language (HTML) graphics and text content resident within the invention.

It is another feature of embodiments of the invention to provide a ready means of communication to a plurality of externally mounted building and process measurement devices comprising, but not limited to, temperature, pressure, flow and humidity measurement and control devices.

It is another feature of embodiments of the invention to provide a supervisory role in monitoring and reporting the normal operation of building automation, heating, ventilating and air conditioning components and/or subsystems with particular emphasis on the ability to indicate visually and report via electronic mail when installed into an existing Ethernet-TCP/IP communications network, with access to an electronic mail server.

It is yet another feature of embodiments of the invention to provide a building automation, monitoring and/or operating system which is easy to operate and does not require specialized training or the use of external programming equipment or tools for configuration and commissioning.

Embodiments of the invention comprise a microprocessor-based computer running, for example, the Microsoft™ Windows-CE operating system having a plurality of memory means operative to store therein a plurality of predetermined and preprogrammed programs for selection and configuration by means of a touchscreen interface, an integral computer monitor screen and preprogrammed graphical depictions of typical heating, ventilating and air conditioning components, devices and subsystems. The invention is contained within a relatively small enclosure.

### BRIEF DESCRIPTION OF THE DRAWINGS

FIG. 1 is a diagram of an exemplary HVAC control system in embodiments of the invention

FIG. 2 depicts user interfaces presented to the user during system set up.

FIG. 3A is a pictorially based graphical representation of an initial grouping of several heating, ventilating and air conditioning devices, components and/ or subsystems

FIG. 3B is a pictorially based graphical representation of a more detailed grouping of the building automation, monitoring and/or control system chosen in graphic depicted in FIG. 3A.

FIG. 3C is a pictorially based graphical representation of the heating, ventilating or air conditioning system, components and/or subsystem as configured and defined by the subsequent choices made by selections depicted in FIGS. 3A and 3B.

FIG. 4 is a flowchart of an exemplary set up process.

### DETAILED DESCRIPTION

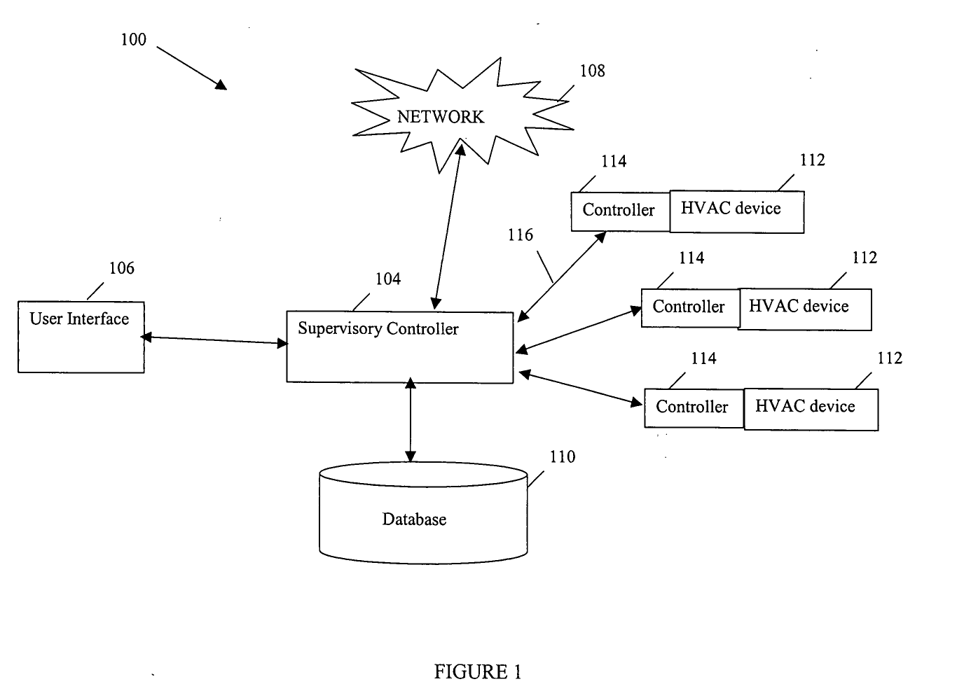

Embodiments of the invention relate to an HVAC control system. The HVAC control system has several features that distinguishes it from other HVAC building control systems. FIG. 1 is a diagram of an exemplary HVAC control system 100 in embodiments of the invention. The HVAC control system is a tiered system that uses a supervisory controller 104 and controllers 114 at the equipment level. The supervisory controller 104 is a microprocessor based device that controls scheduling, remote control of setpoints, remote monitoring, alarming, trending and graphic display. The supervisory controller 104 executes a computer program to performed functions described herein. The supervisory controller 104 is connected to an external network 108 to provide for communications with external sources (e.g., email alerts to external devices). Network 108 may be a TCP/IP network including LAN, WAN, Ethernet, Internet, etc or a dial-up connection via an internal modem in the supervisory controller 104. Reports generated by the supervisory controller 104 may be sent to external source via network 108.

The equipment level controller 114 controls setpoints, tuning parameters, inputs and outputs. The equipment level controller 114 will operate without the supervisory controller 104 although without its features.

A user interface 106 is part of supervisory controller 104 and provides a display screen for the user to view various system information as described in further detail herein. Further, the user interface 106 includes an input device for the user to enter information. The input device may be implemented using known input devices such as a touchscreen, keypad, keyboard, mouse, etc.

Database 110 is connected to the supervisory controller 104 and contains control data, display data and operating parameters. The control data, display data and operating parameters are predefined and stored in the database 110 to facilitate setup of the control system 100. The display data presents pictorial representations of HVAC systems, sub-systems, components, etc. As described in further detail herein, the user may define the HVAC system selecting predefined system elements. The control data is used to set control routines for monitoring/controlling system parameters at HVAC equipment 112. The control data instructs the equipment controller 114 of what parameters to monitor, and when, in response to user inputs in setting up the system.

HVAC devices 112 include a variety of HVAC elements such as heating/cooling units, fans, dampers, etc. The supervisory controller 104 interacts with the HVAC devices 112 through controllers 114 over a local bus 116. The local bus may be a serial bus as known in the art to establish communications between the controllers 114 and the supervisory controller 104. In one example, the serial bus is an RS485, multidrop serial bus. The bus 116 may also be a wireless bus. The controllers 114 monitor parameters at the HVAC devices 112 and adjust operating parameters of the HVAC devices in accordance with control data in the equipment controller 114.

A feature of the HVAC control system 100 is how these functions are initially set up. Other systems require one or more additional software packages to program. Some require classes. These may be required at the equipment controller level, another at the supervisory level and yet another for the graphics. There is a detailed learning curve that all employees must go through to become competent at programming. A laptop computer is required to perform all this programming.

The HVAC control system 100 of embodiments of the invention requires no additional software or computers. The entire system is designed to be intuitive by nature. An HVAC technician with minimum computer skills can set up the HVAC control system. The entire setup is done through the user interface 106 and the supervisory controller 104 that contains its own computer and software. Very simple questions about the type of equipment to be controlled are asked. These are questions an HVAC technician would be very comfortable answering. There are graphic pictures to assist in understanding.

While other systems are labor-intensive, the HVAC control system 100 is very simple and quick to set up. In some applications, the supervisory controller 104 automatically programs the equipment controllers 114 based on common system configurations. The advantage is a system that most technicians can install, lower labor costs over the life of the system, no additional equipment costs and unaffected by technician turnover.

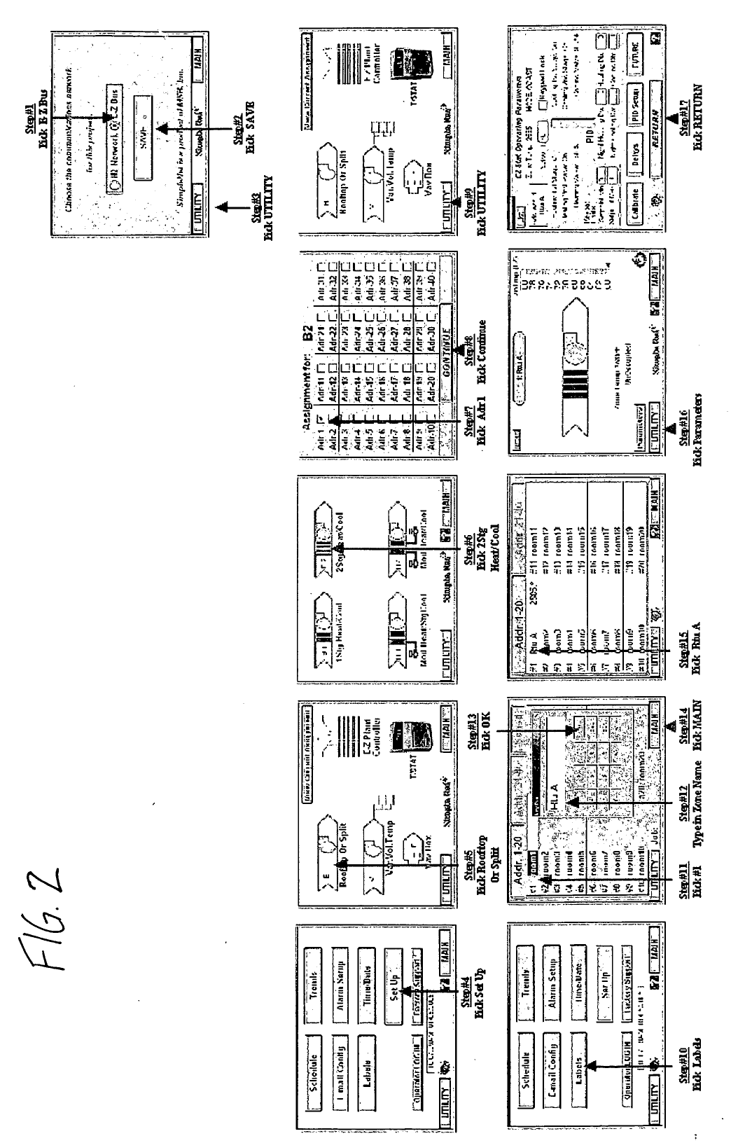

FIG. 2 illustrates an exemplary process for setting up an HVAC control system. As shown in FIG. 2, the user walks through a series graphical interfaces to set up the control system. It is understood that FIG. 2 illustrates a single example of set up of the HVAC control system and that a number of other set ups may be implemented using the HVAC control system 100.

As shown in FIG. 2, at step 1, the users selects the type of communication network used to establish communications between the equipment controller 102 and controllers 114. In the example in FIG. 2, the user selects a bus based protocol referred to as E-Z bus and saves the selection at step 2. At step 3, the user selects a utility menu through a utility icon.

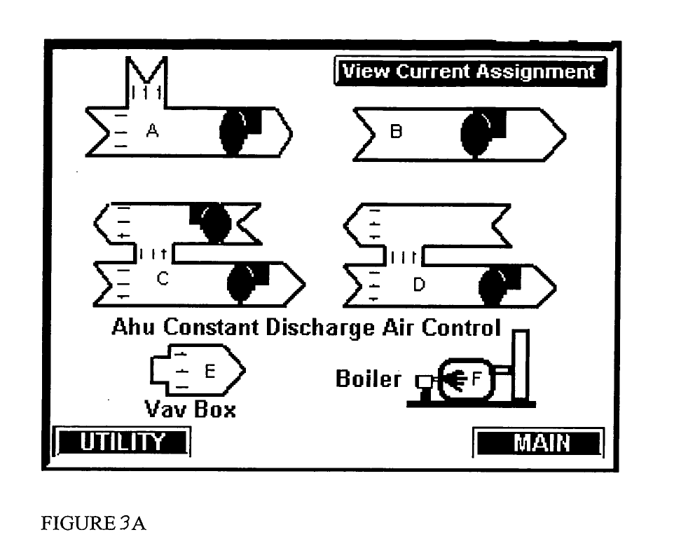

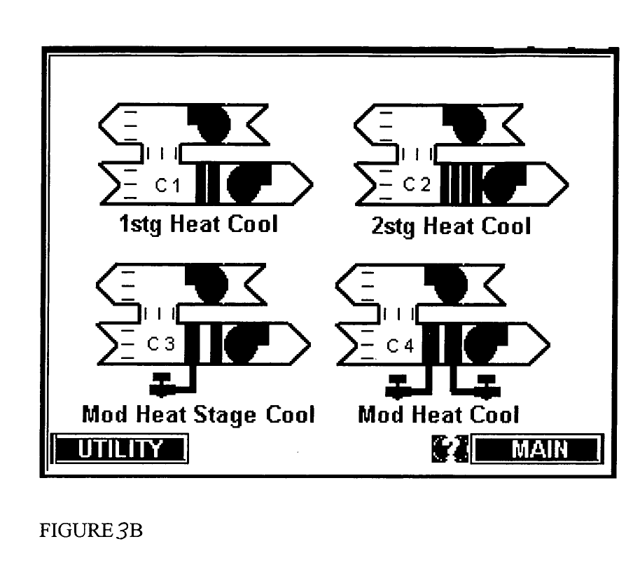

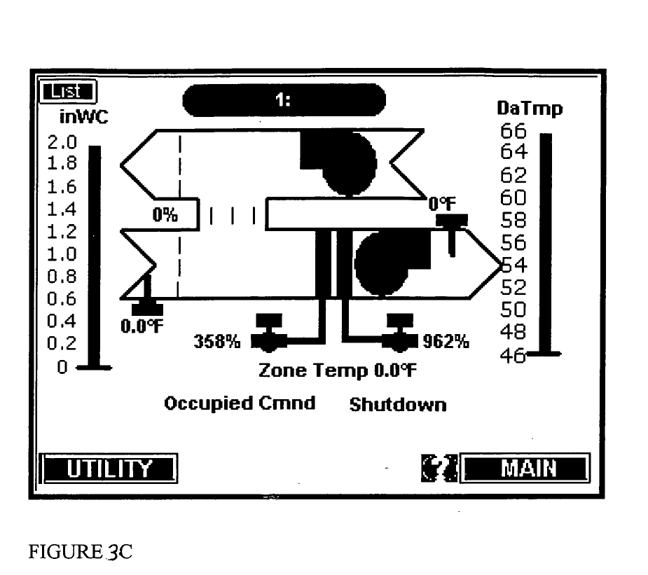

At step 4, the user initiates a set up routine by selecting a set up icon though a utilities menu. Launching the set up routine allows the user to select air paths, selecting heating/cooling choices, assign zones, etc. As shown in FIG. 2, at step 4 the user is presented with an air path selection screen, at which the user selects the rooftop or split option. It is understood that other options are presented to the user such as variable volume/temperature set up, variable air volume, etc. FIG. 3A depicts another grouping of heating, ventilating and air conditioning components and subsystems. Selection of the desired component is accomplished by touching the graphical image of the component representation.

Once the user selects the rooftop or split option, the user is presented with a heating/cooling choice option as shown at step 6. The heating/cooling choices include features such as 1 stage heat/cool, 2 stage heat/cool, modulated heating, etc. FIG. 3B shows other graphical representations further defining the combination and arrangement of heating, ventilating and air conditioning components. Selection of the desired component is accomplished by touching the graphical image of the component representation. Referring to FIG. 2, in this example, the user picks 2 stage heat/cool and flow proceeds to step 7 where the user assigns an address for this zone.

The user assigns an address for this zone by selecting one or more addresses at step 7. The address corresponds to an equipment controller 114. Thus, by selecting an address, the user has specified that equipment controller 1, for example, is associated with a 2 stage heat/cool unit (selected at step 6). As described in further detail herein, this allows the supervisory controller 104 to transmit the appropriate control data to the equipment controller 114 for a 2 stage heat/cool unit. This greatly facilitates system set up as the installer does not need to program equipment controllers 114 manually.

By selecting continue at step 8, the air path interface is presented again and the user selects the utility icon at step 9. The user is presented the utility interface and selects a label icon at step 10 to launch a label interface. The label interface allows the user to assign a descriptive label to a zone. Through steps 11, 12 and 13, the user selects a zone by its address and enters a textual description.

The user can also set parameters for each HVAC device though a main menu selected at step 14. As shown at step 15, the user selects one zone by address and is presented with a graphical representation of the HVAC device for that zone. By selecting a parameters icon at step 16, an operating parameter interface is presented as shown at step 17. Through the operating parameters interface, the user can define operating parameters for the HVAC device. Operating parameters include setpoints, PID setup, heating and cooling for day/night, etc.

FIG. 3C depicts a fully configured and operating pictorially graphic representation of a heating, ventilating or air conditioning system, component or subsystem.

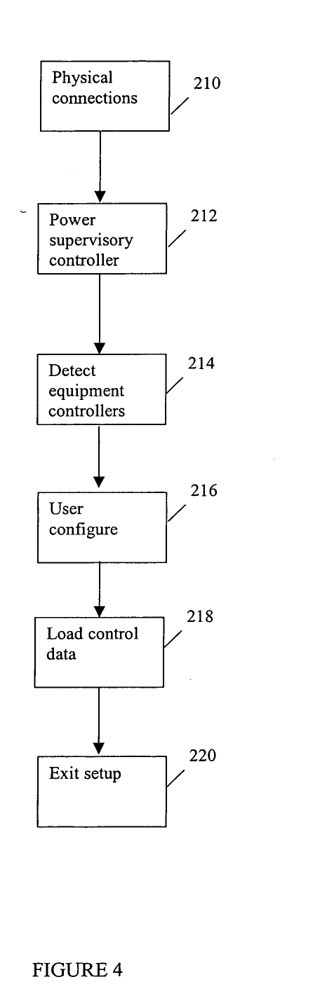

FIG. 4 is a flowchart of an exemplary set up process. The process begins at step 210 where the connections between the supervisory controller 114 and the equipment controllers 114 are made. The equipment controllers 114 are connected to HVAC devices 112. The equipment controllers are also connected to bus 116 to communicate with supervisory controller 104. The supervisory controller is powered up at step 212 at which point the supervisory controller sends a query message on the bus 116 to detect equipment controllers 114 at step 214. The controllers 114 respond with an acknowledgment and the supervisory controller 104 records the address of the responding controllers 114. This allows supervisory controller 104 to which addresses correspond to controllers 114. For example, controllers 114 may be located on bus addresses 1, 4, and 16.

At step 218, the user configures the controllers as described above with reference to FIG. 2. The user selects a type of HVAC device from the graphical interfaces and then assigns an address to the device. The supervisory controller 104 can detect a conflict between the automatically detected address and the user configured address. For example, if the user specifies that a roof top unit should be assigned to address 12, but the supervisory controller did not detect a controller at address 12, this will flag an error condition.

Once the user assigns a valid address to the specified type of HVAC device, the supervisory controller then loads the necessary control data into the controller 114 at step 218. The control data is retrieved from database 110 and sent to controllers 114. Controllers 114 are addressable on bus 116 so that the correct control data is transmitted to each respective controller. The control data defines how the controller 114 interacts with the HVAC device 112. This may include how conditions are sensed at the HVAC device and how commands are provided to the HVAC device. The set up process ends at step 220.

The system can operate once the HVAC devices are selected by the user and addresses associated with the HVAC devices. The supervisory controller can load default operating parameters into controllers 114 to provide for immediate operation. Of course, the user can adjust operating parameters of the controllers 114 through user interfaces such as those shown in FIG. 2.

The current control data and operating parameters (either default or user-defined) are stored in database 110. In the event that a controller 114 fails, the replacement controller can be updated by pushing the control data and operating parameters to the newly installed controller. This greatly facilitates installation of a new controller.

As described above, the exemplary embodiments can be embodied in the form of computer-implemented processes and apparatuses for practicing those processes. The exemplary embodiments can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the embodiments. The exemplary embodiments can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the embodiments. When implemented on a general-purpose microprocessor, the computer program code segments configure the microprocessor to create specific logic circuits.

While this invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method of performing an HVAC system set up, the method comprising:
coupling a supervisory controller to a plurality of equipment controllers, the equipment controllers communicating with the supervisory controller over a bus;
the supervisory controller polling addresses associated with the bus to detect the presence of equipment controllers on the bus;
associating an HVAC device with each controller in response to an HVAC device designated through a user interface and assigning an address to the HVAC device; and
the supervisory controller retrieving control data from a database and loading the control data into the equipment controllers;
the supervisory controller loading operating parameters into the equipment controllers.

2. The method of claim 1 wherein the operating parameters are default operating parameters retrieved from the database.

3. The method of claim 1 wherein the operating parameters are user-defined operating parameters obtained through the user interface.

4. The method of claim 1 wherein the user interface is a graphical interface presenting graphical representations of HVAC devices.

5. The method of claim 4 wherein the graphical interface includes an air path screen for accepting input from the user for defining an air path.

6. The method of claim 5 wherein the graphical interface includes a heating/cooling screen for accepting input from the user for defining a heating/cooling device.

7. The method of claim 1 wherein the supervisory controller communicates with external sources via a communications network.

8. The method of claim 7 wherein the communications network is a TCP/IP network.

9. The method of claim 7 wherein the communications network is accessed though a dial-up modem in the supervisory controller.

10. The method of claim 1 wherein the supervisory controller verifies that an equipment controller is associated with a user-specified address.

11. A system for performing an HVAC system set up, the system comprising:
a supervisory controller;
a plurality of equipment controllers communicating with the supervisory controller over a bus;
a database storing predefined control data for a plurality of HVAC devices;
the supervisory controller polling addresses associated with the bus to detect the presence of equipment controllers on the bus;
the supervisory controller associating an HVAC device with each controller in response to an HVAC device designated through a user interface and assigning an address to the HVAC device; and
the supervisory controller retrieving control data from a database and loading the control data into the equipment controllers;
the supervisory controller loading operating parameters into the equipment controllers.

12. A computer program product for performing an HVAC system set up, the computer program product comprising:
a storage medium readable by a processing circuit and storing instructions for execution by the processing circuit for facilitating a method comprising:
polling addresses associated with a bus to detect the presence of equipment controllers on the bus;
associating an HVAC device with each controller in response to an HVAC device designated through a user interface and assigning an address to the HVAC device; and
retrieving control data from a database and loading the control data into the equipment controllers;
loading operating parameters into the equipment controllers.
